(19) United States
(12) Patent Application Publication
(10) Pub. No.: US 2010/0313614 A1
(43) Pub. Date: Dec. 16, 2010

(54) Municipal bicycle sharing system

(76) Inventor: S. Ryan Rzepecki, Wattsburg, PA (US)

Correspondence Address: RICHARD K THOMSON, ATTORNEY, 7691 FAIRLANE DRIVE, FAIRVIEW, PA, 16415, US

(21) Appl. No.: 12/655,400

(22) Filed: Dec. 30, 2009

Related U.S. Application Data
(63) Continuation-in-part of application No. 12/456,227, filed on Jun. 12, 2009.

(51) Int. Cl. B62H 5/00; E05B 71/00; E05B 47/00

(52) U.S. Cl. 70/233

(57) ABSTRACT

A bike share system with the flexibility to anchor the rental bike anywhere at the end of the trip employs a remotely operable lockbox which incorporates a wireless communication card with a GPS receiver. The lock system includes a scissor clamp for grasping the bicycle seat support post and a pair of extended fingers of the scissor clamp which are retained by the clamshell halves of the lockbox. One arm of a U-shaped retainer can be extended into throughbores of first and second ears positioned on opposing sides of the bicycle wheel to lock the wheel against rotation. A mechanical locking device has teeth which engage with protrusions on the other arm of the U-shaped retainer to prevent its movement relative to the lockbox maintaining the other arm in wheel immobilizing position.

The present application is a continuation-in-part of U.S. patent application Ser. No. 12/456,227 filed Jun. 12, 2009.

### BACKGROUND AND SUMMARY OF THE INVENTION

The present invention is directed to the field of transportation. More particularly, the present invention is directed to a stationless bicycle sharing system and method of conducting such a business from a remote location.

The sustainability movement has spawned the growth of bicycle rental operations, as a means of improving mobility and reducing automobile dependence. The systems proposed thus far typically involve the provision of a locking station and a rental kiosk where credit card payment can be made. The requirement of such features limits the growth of the business since it requires land acquisition and installation of expensive infrastructure. It also creates a logistical problem for users since the rented bicycle must be returned to one of a limited number of pre-determined locations.

The present invention removes these down-sides from a bicycle sharing system by allowing the rented vehicle to be locked to any authorized object such as a light post, a telephone pole, a guardrail, or the like. The bicycles themselves will be distinctive in design and color and the lockbox will feature an illuminated status screen. When the lock is engaged and the transaction is complete, the status screen will display “Available”. When the bike is placed on temporary hold the screen will display “Hold”. When the bike is in need of repair, the status screen will display “Repair”. Finally, if the bike is improperly parked and flagged for removal, the screen will display “Relocate”.

Additional features of the bicycle sharing system of the present invention include the capability to unlock the bicycle for use from a remote location by using a wireless communication device secured within a lockbox, making the use of kiosks or stands unnecessary. The lockbox will also include a global positioning system (GPS) tracking unit that tracks the real time position of each bike. The GPS receiver and wireless device will be powered by onboard battery(ies) that is/are recharged by a dynamic recharging means such as, for example, a bicycle hub dynamo that recharges the battery(ies) while the bicycle is in motion. The GPS/wireless communication system allows a computer-based, central monitoring and control system to track the position of each bicycle in the system, collect trip data for use by the system administrators and end users, and transmit unlock commands to the manually locked/remotely unlocked locking system on the bicycle when a valid request is received from a potential customer. This electronic locator system should also reduce/eliminate pilfering of bicycles utilized in the system.

The present invention comprises a stationless bike share system for use in municipalities which includes a) a plurality of bicycles, each bicycle of the plurality having a locking system including a lockbox, each lockbox including a GPS tracking system and a wireless communication device, each lockbox functioning as a bicycle securing means to retain a bicycle to a stationary object against unauthorized removal, each lockbox including locking means which is manually locked and remotely unlocked; b) battery means for powering the GPS tracking system and the wireless communication device; c) a remote monitoring system for determining location of each of the bikes, authorizing use by remotely unlocking the locking means upon receipt of a confirmed request. The system further includes an internal hub dynamo to recharge the battery means while the bicycle is in motion. The locking system further includes a U-shaped lock, the lockbox having a plurality of recesses, each of the plurality of recesses designed to receive and secure an arm of said U-shaped lock when the arm is manually inserted therein. The system, more specifically, the lockbox, includes a keypad.

Preferably, the lockbox can be unlocked by a remote signal in response to at least one of five inputs: a) an authorized text “Unlock” message; b) a cell phone request where a user provides proper responsive information; c) a smartphone application request; d) direct entry of account number into the keypad; e) an RFID coded card or other swipe card which communicates customer information to the lockbox.

The keypad further has buttons which include a “Hold” button to allow retention of control of said bicycle for a limited period, a “Repair” button transmitting a signal to said remote monitoring system advising that the bicycle is in need of service, and “Relocate” advising the remote monitoring system of a need to move the bicycle to an alternate location. It is desired that law enforcement personnel will have the means to activate the “Relocate” button. The keypad further includes an “Available” light which illuminates when the arms of said U-shaped lock are manually inserted in the plurality of recesses without one of said auxiliary buttons being depressed.

The invention further includes a method of conducting a stationless bicycle rental business, the method comprising the steps of a) equipping a plurality of bicycles each with i) a GPS tracking system; ii) a wireless communication device; iii) a battery to power the GPS tracking system and the wireless communication device; iv) a lockbox containing the GPS tracking system and the wireless communication device, as well as a remotely operable lock; b) establishing a central monitoring and control system on a remote computer; c) determining a particular real-time position for a particular bicycle; d) transmitting the real-time position to the central monitoring and control system; e) receiving a signal from a prospective customer in proximity to the particular bicycle at the central monitoring and control system; f) storing bits of information contained in the received signal in the database of the computer; g) comparing said stored bits to information contained in said database; h) if the stored bits do not match existing data in the stored bank, establishing a new account for the prospective customer then proceeding to the next step, and if the stored bits do match existing data in the stored bank, proceeding to the next step; j) sending a signal to said remotely operable lock unlocking the lock allowing use of the bicycle by the prospective customer. An additional method step of equipping the bicycle with a dynamic means to recharge said battery during movement of the bicycle is contemplated. The unlocking method step is performed in conjunction with the receipt by the central monitoring and controlling computer of a signal selected from a group consisting of a) an authorized text “Unlock” message; b) a cell phone request where a user provides proper responsive information; c) a smart phone application request; d) direct entry of an account number into the keypad; and, e) an RFID coded card or other swipe card which transmits account information to the lockbox.

The preferred lock system of the present invention comprises a) a scissor-clamp formed by a first arm and a second arm intertwined by a pivot post, each arm having a gripping claw at one end which grasps a seat tube of a bicycle and an extending finger at a distal end of the arm; b) a lockbox having a bottom wall and a lid, the bottom wall and the lid engaging the extending finger of each arm in a closed, latched position securing the extending fingers against movement thereof and preventing the scissor clamp from being removed from the seat tube of the bicycle. In addition, the lock system includes c) a U-shaped retainer having a first arm with a plurality of cylindrical protrusions, a second arm which can be extended outside the lockbox; d) a mechanical locking device which engages the first arm of the U-shaped retainer preventing relative movement between the U-shaped retainer and the lockbox; e) a first ear protruding from a lower side of the bottom of the lockbox on a first side of a wheel of the bicycle, the first ear having a first throughbore; f) a second ear protruding from a lower side of the bottom of the lockbox on a second side of the wheel of the bicycle, the second ear having a second throughbore which is aligned with the first throughbore; whereby the second arm of the U-shaped retainer is extended through the first and second aligned throughbores and the wheel of the bicycle immobilizing the bicycle. The U-shaped retainer can be extended about a post prior to the first arm being engaged by said mechanical locking device thereby securing and immobilizing the bicycle.

The lock box contains a battery and an electronic actuator for the mechanical locking device. Also, a support post extends from the hub of the wheel above which the lockbox sits up to and into the lockbox. This support post provides a path for an electrical connecting wire between a hub generator and the battery contained in the lockbox.

The first arm of the U-shaped retainer includes a plurality of annular protrusions on at least a portion of its length. The mechanical locking device, then, includes an extendable member having a plurality of teeth which interdigitate with the annular protrusions on the first arm to preclude movement thereof. A solenoid is attached to the extendable member to disengage said mechanical locking device responsive to an authorized signal from an electronic touch pad. At least one illuminated light is positioned in the lockbox and shines out through at least one portal on a rear surface of the lockbox to render the bicycle more visible. More preferably, the at least one illuminated light comprises at least two illuminated lights and the at least one portal comprises at least two portals on the rear surface of said the box.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1a is a schematic side view of a first embodiment of the bicycle utilized in the stationless bicycle sharing system of the present invention;

FIG. 1b is a schematic front view of a lockbox used in conjunction with the first embodiment of the present invention;

FIG. 1c is a schematic rear view of the lockbox shown in FIG. 1b;

FIG. 2 is a schematic depiction of the various component elements of the municipal bike sharing system of the present invention;

FIG. 3a is a logic flow chart employed by the activation computer for unlocking responsive to a text entry;

FIG. 3b is a logic flow chart employed responsive to an automated phone call;

FIG. 3c is a logic flow chart employed responsive to smart phone application request;

FIG. 3d is a logic flow chart employed responsive direct entry into the lockbox;

FIG. 4A is a schematic perspective of a first embodiment of the scissor clamp of the present invention in an open position;

FIG. 4B is a schematic showing the position of the scissor clamp in FIG. 4A as it relates to the bicycle;

FIG. 4C is a schematic perspective showing the first embodiment of the scissor clamp shown in closed position;

FIG. 4D is a schematic showing the position of the scissor clamp in FIG. 4C as it relates to the bicycle;

FIG. 4E is a schematic perspective of the lockbox being closed around the first embodiment of the scissor clamp;

FIG. 4F is a schematic of the closing of the lockbox as shown in FIG. 4E as it relates to the bicycle;

FIG. 4G is a schematic perspective of the lockbox shown locked around the fingers of the first embodiment of the scissor clamp;

FIG. 4H is a schematic of the lockbox as shown in FIG. 4G as it relates to the bicycle;

FIG. 5 is a top perspective view of the open lockbox;

FIG. 6A is a front view of the first embodiment of the locking system of the present invention;

FIG. 6B is a side view of the first embodiment of the locking system of the present invention;

FIG. 7A is a schematic front view depicting a bicycle being positioned to be secured to a pole;

FIG. 7B is a schematic top view of the bicycle shown in FIG. 7A;

FIG. 7C is a schematic front view depicting a bicycle secured to a pole;

FIG. 7D is a schematic top view of the bicycle shown in FIG. 7C; and,

FIG. 8 is a perspective rear view of the lockbox mounted on a bicycle.

### DETAILED DESCRIPTION OF THE PREFERRED EMBODIMENT(S)

The two critical features of the stationless bicycle share system of the present invention are 1) an effective locking mechanism and, 2) the electronics package including the battery-powered GPS unit and the wireless communication device, the battery(ies) being recharged by a dynamic recharger such as an internal hub dynamo mounted on one of the wheels.

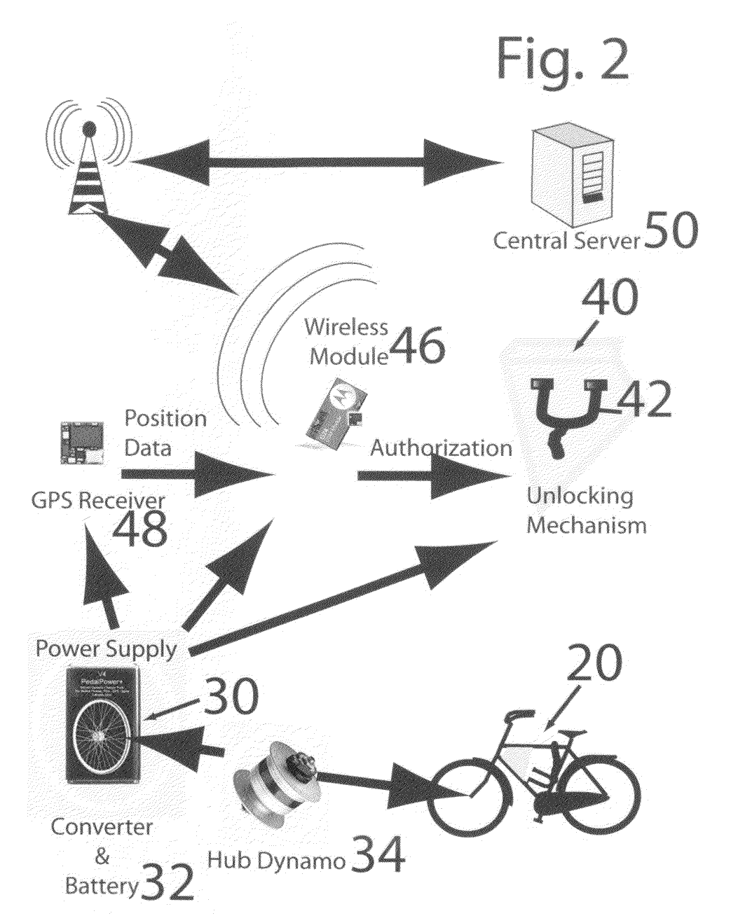

As depicted in FIG. 2, the components of the bike share system include a rugged, reliable bicycle 20, a rechargeable power supply 30 system including a power converter 31 and battery 32, a hub dynamo 34. One suitable bike is available from Worksman Cycles of New York City, N.Y., manufacturers of sturdy industrial cycles for over a century. It is preferred that the bicycle be painted with a retro-reflective powder coating of the type commercially available from Halo Coatings, a subsidiary of MKB LLC of Port Clinton, Ohio, under the trademark “Hi-Viz”. It is desired that the cycles used in the cycle share system to be marketed under the trademark “MuniBike”, be easily identifiable by the color and color scheme utilized such as an taxicab yellow, for example. The hub dynamo 34 can be of the “V4” type available from PedalPower+ along with the connector cable and converter utilized to charge a lithium ion battery 32.

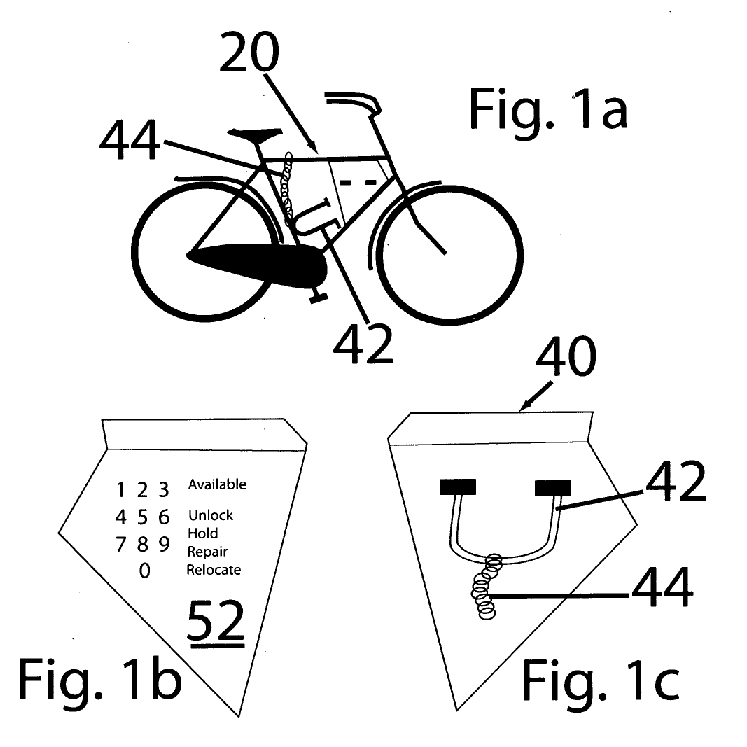

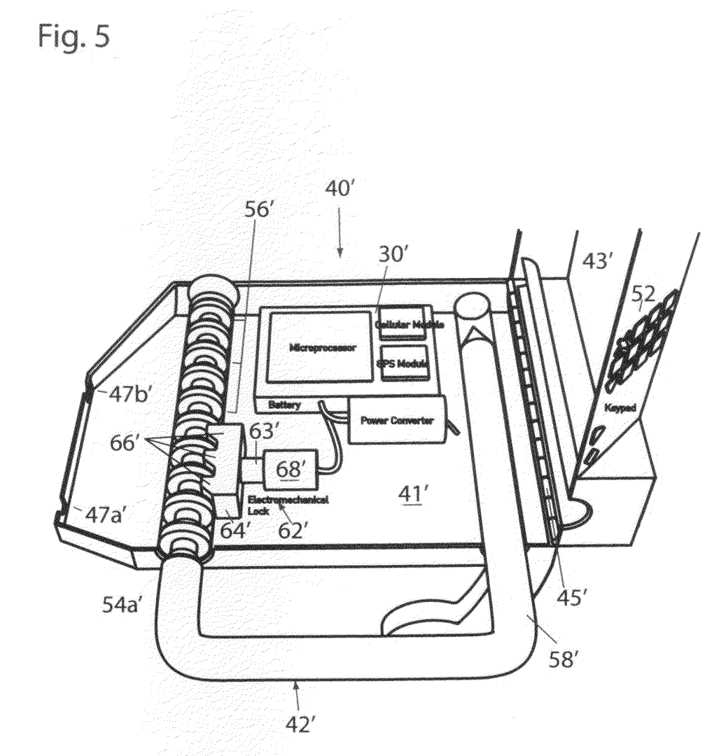

Each bicycle 20 is equipped with a lockbox 40 with a remotely operable locking mechanism which receives a U-shaped lock engaging device 42. Within the lockbox 40 will be a wireless module 46 with a separate or associated GPS receiver 48. One suitable system is a Motorola M2M card with an integrated GPS receiver which can offer a range of solutions for several different networks. The wireless communication card/GPS receiver is powered by battery 32. Preferably, on the side of the lockbox 40 near the lock insertion point (FIG. 5), is a keypad 52 with a series of illuminatable messages including “Available”, “Unlock”, “Hold”, “Repair”, and “Relocate” (FIG. 1B).

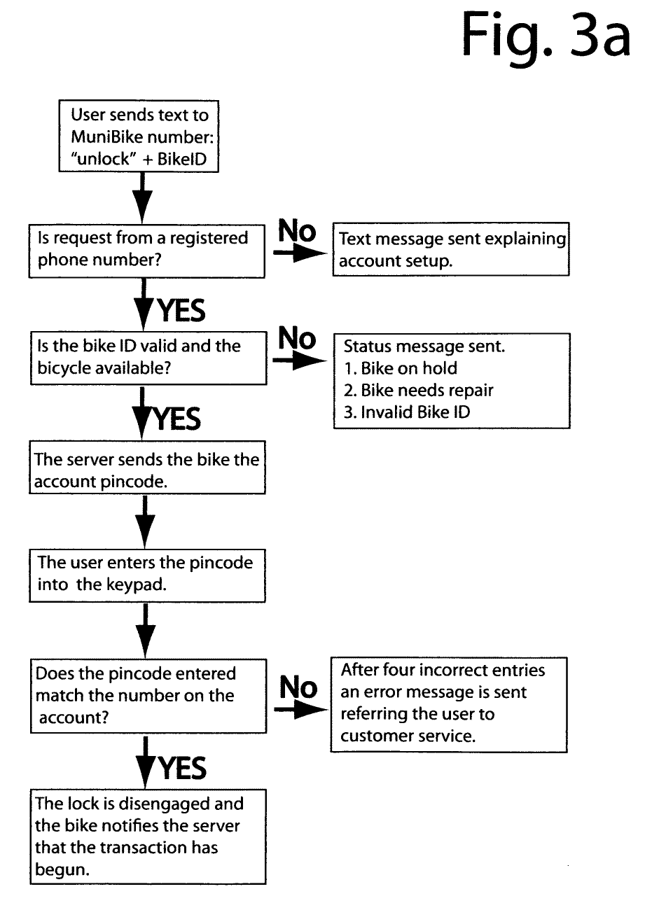

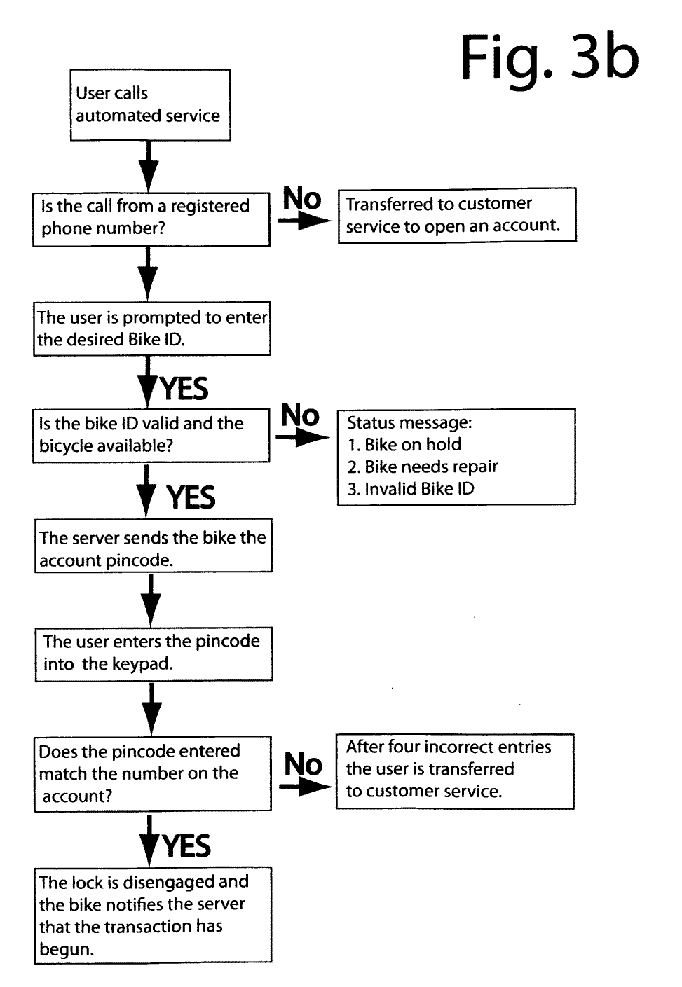

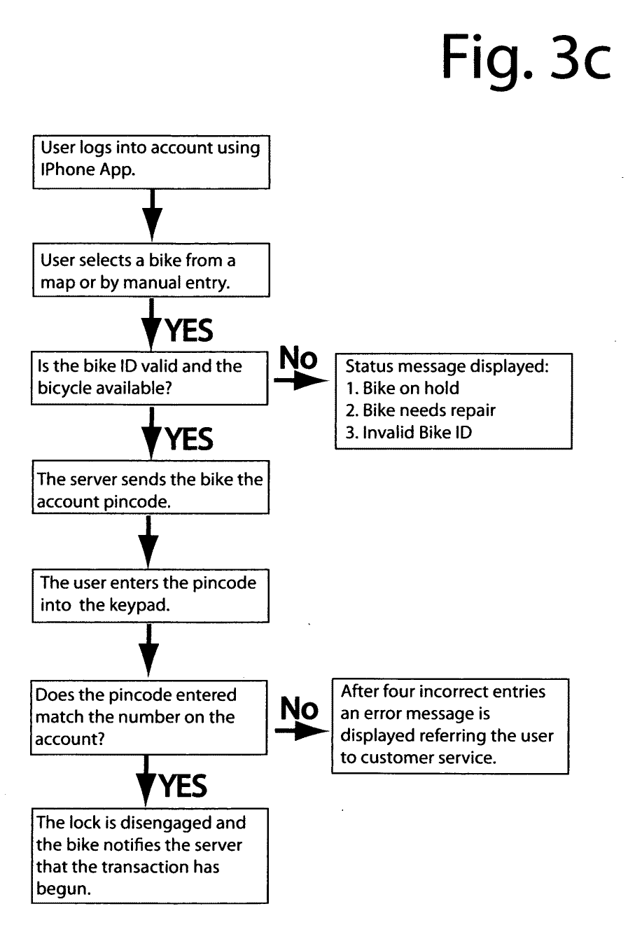

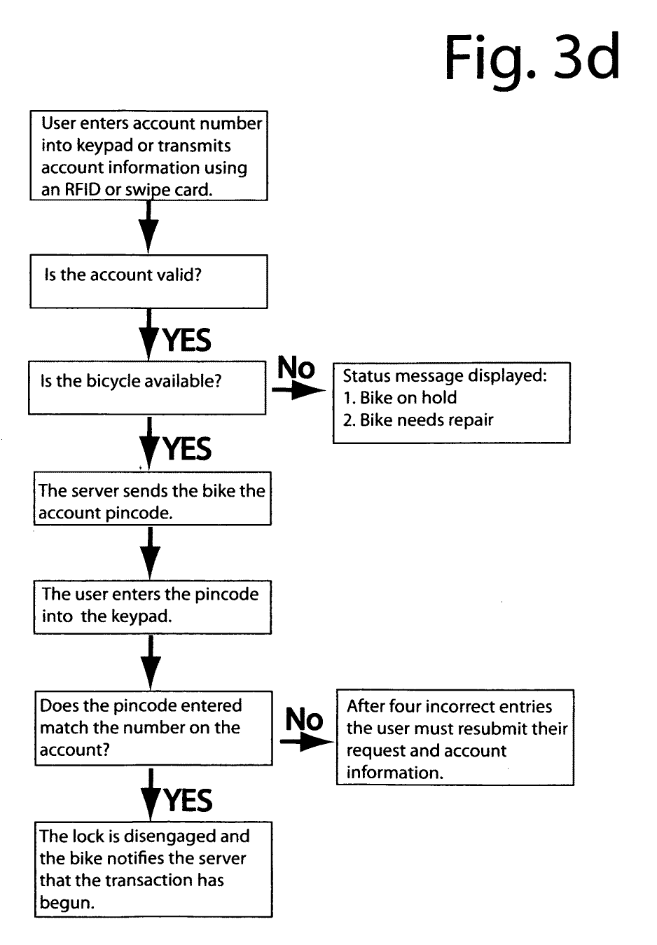

A central server 50 (FIG. 2) processes rental requests received by one of a number of means: 1) cell phone text, 2) an automated phone call; 3) a smartphone communication; 4) direct entry of the account number and authorization code into the keypad 52; and, 5) an RFID code or other swipe card which communicates account information to the lockbox. The logic sequence for a texted message is depicted in FIG. 3a. Before sending a text request a user must be registered with the system, otherwise they will receive an error message. Once registered, a user will text his unlock request along with the Bike ID to the MuniBike contact number. A monitoring and control system will be set up on the central server 50. The central server 50 will compare the phone number from which the request is made to its database to verify that the number and user information is recorded. If there is no corresponding number in the database, the server 50 sends a text message advising the potential user steps which need to be taken to set up an account. If the information matches a registered phone number, the central server then verifies that the bike ID is valid and that the bike is available. When the bike is available, the central server 50 sends the user's account pincode to the wireless module 46. The prospective user enters her/his pincode using the keypad 52 and when it matches the code sent from the server, the lock is disengaged and the lockbox 40 notifies the central server 50 that the rental transaction has begun.

FIG. 3b depicts the logic sequence followed by the central server 50 for an automated phone call. When the call comes in, the server compares the originating number to numbers stored in the database. If there is no match, the potential user is transferred to customer service to allow an account to be set up. If there is a match, the automated call prompts the potential user to input the bike ID either verbally or using the keys of the phone. If the bike is not available, a voice message will explain the reason. If the bike is available, the server 50 again sends the pincode to the bike, where the potential user inputs her/his code using the keypad to initiate the rental session.

Smartphone application access is depicted in FIG. 3c. The potential user logs in using a smartphone application. S/he may then select a bike from a display map showing the positions of all available bikes in the system or by entering a bike ID manually. The central server 50 compares the bike ID to the information stored in its database. If the bike is unavailable, an error message is displayed on the phone's screen.40. If the bike is available, the user's pincode is transmitted to the lockbox 46 and if the user enters the correct code, the lock is disengaged and the server 50 is notified that the rental session has begun.

FIG. 3d depicts the logic steps employed when the potential user makes her/his request directly from the lockbox 40. The user inputs the account number (generally her/his telephone number,) directly into the lockbox 40 using the keypad 52 or by using an RFID or magnetic swipe card. The wireless communication card sends the account number 46 to the central server 50 which compares the input information to the information stored in its database. If there is a match and, hence, a valid account, the server verifies that the bike is available, and sends the pincode to the bike. If the user enters the correct pincode, the remote locking mechanism disengages the U-lock 42 and advises the server 50 that the rental session has begun.

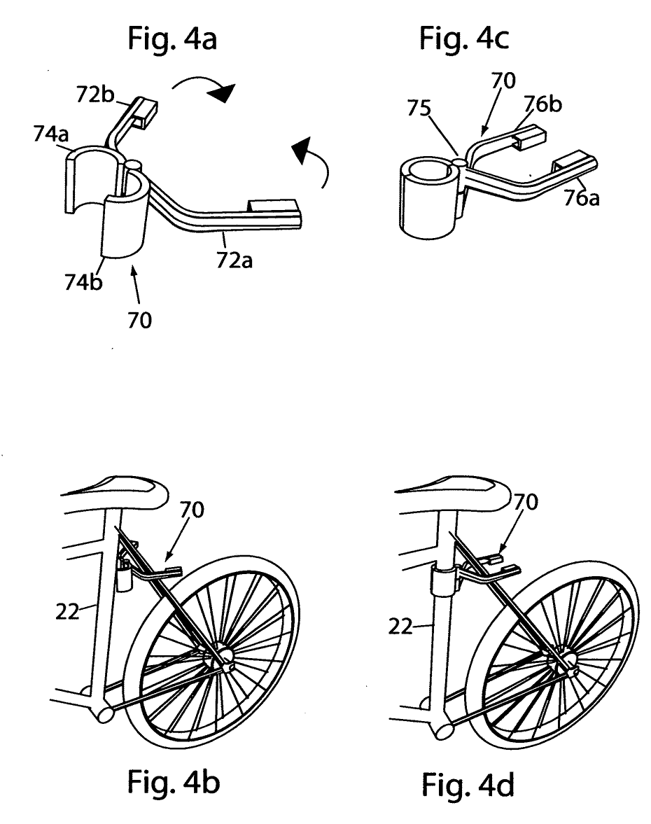

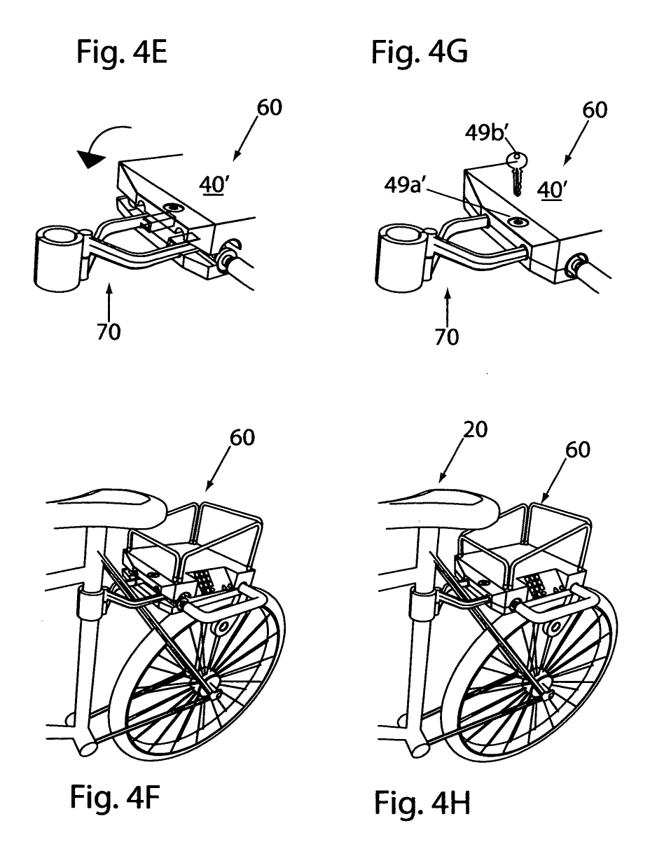

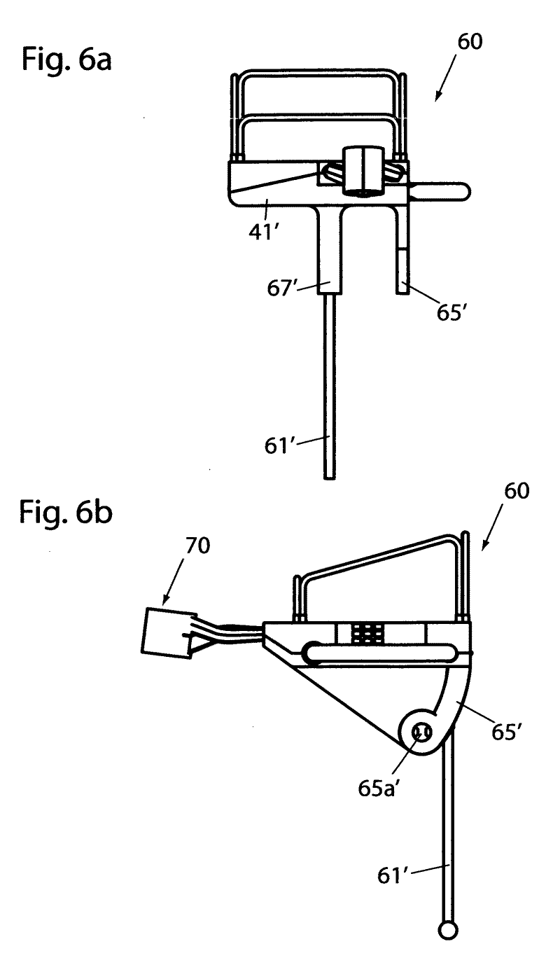

The preferred locking system of the present invention is depicted in FIGS. 4E-4H, FIG. 6A, 6B generally at 60. Locking system 60 includes a scissor clamp 70 and lockbox 40′. Scissor clamp 70 includes a first arm 72a with first gripping claw 74a on one end and a first extending finger 76a on a second opposite end. Second arm 72b with a second gripping claw 74b and second extending finger 76b is pivotally interconnected to first arm 72a at pivot post 75. As seen in FIGS. 4A-4D, gripping claws 74a, 74b of scissor clamp 70 are entwined about seat support post 22. Lockbox 40′, which includes a bottom wall 41′ and a top wall 43′ attached thereto by piano hinge 45′ (FIG. 5), can be clamped around fingers 76a and 76b of scissor clamp 10 receiving said fingers in recesses 47a′ and 47b′. Lock 49a′ is then secured by key 49b′ (FIG. 4G) to fixedly attach lock system 60 to bicycle 20.

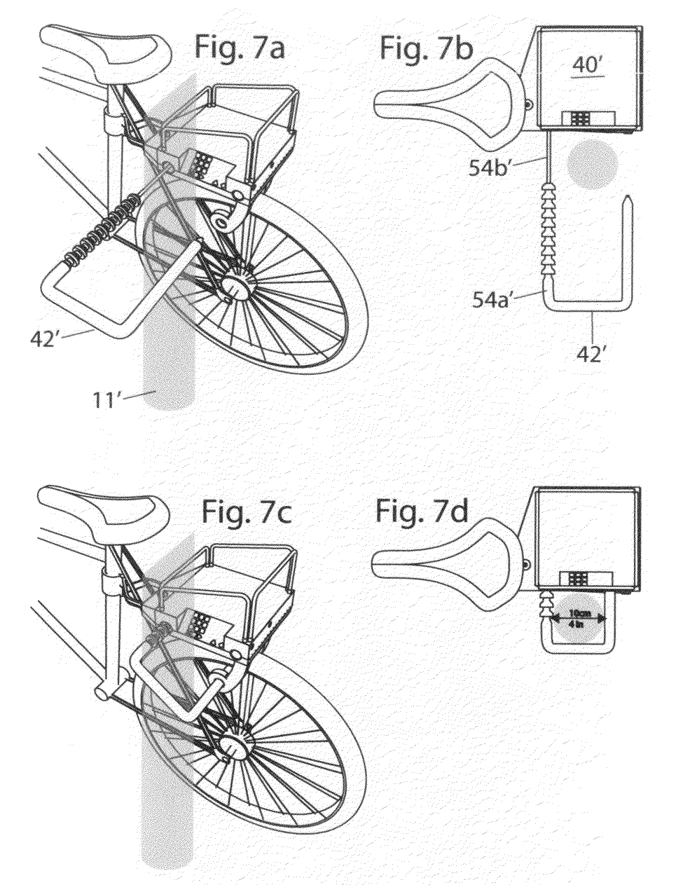

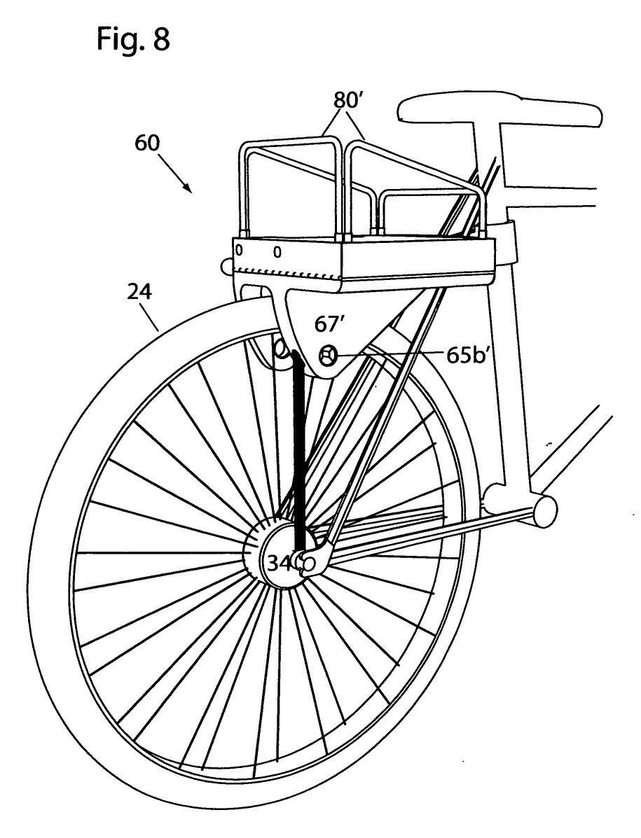

As best seen in FIG. 5, U-shaped retainer 42′ has a first arm 54a′ with a plurality of annular protrusions 56′ extending along at least a portion of its length. Second arm 58′ is smooth and can be pivoted between a first unlocked position in a recess within the bottom wall 41′ of lockbox 40′ to a second locking position seen in FIG. 7C. A mechanical locking device 62′ includes member 64′ with a plurality of teeth 66′ configured to interdigitate with annular protrusions 56′ to preclude movement of U-shaped retainer 42′. Locking device 62′ is mounted on the end of piston 63′ of solenoid 68′ which is used to disengage locking device 62′ at the appropriate time. As best seen in FIGS. 6a, 6b, lockbox 40′ further comprises a first ear 65′ which extends from bottom wall 41′ essentially from one side thereof and will be positioned on one side of bicycle wheel 24. First ear 65′ has a throughbore 65a′ therein near its distal end. A second ear 67′ extends generally from a central portion of bottom wall 41′ and will be positioned on the opposite side of wheel 24 (FIG. 4H). Second ear 67′ has a second throughbore 65b′ which is aligned with first throughbore 65a′. Support post 61′ extends from second ear 67′ to hub dynamo 34 (FIG. 8) to stabilize the lockbox 40′ and to provide a path for an electrical wire to convey electrical power from dynamo 34 to rechargeable power supply 30′. Lockbox 40′ may be provided with a railing 80′ to enable it to serve as a platform for cargo.

When an authorized pincode is entered using keypad 52, piston 63′ of solenoid 68′ retracts mechanical locking device 62′ allowing U-shaped retainer 42′ to be withdrawn from lockbox 40′. If this is for placing a bicycle into use, U-shaped retainer 42′ will be removed from aligned throughbores 65a′, 65b′ where it is disabling wheel 24 and withdrawn from around pole 11 (FIG. 7A), if applicable, and reinserted in the unlocked position within the recess in the bottom wall 41′. As can be seen in FIG. 7b, one end of an extension rod 54b′ telescopes into arm 54a′ to allow it to be extended a sufficient amount to clear pole 11 so that bicycle 20 can be placed into service. The other end of extension rod 54b′ is secured to the sidewall of lockbox 40′. It will be understood that where a suitable securing pole is not available, insertion of U-shaped retainer 42′ into aligned throughbores 65a′, 65b′ and wheel 24 will serve to immobilize the bicycle 20 until an authorization code is entered into the keypad 52.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

I claim:

1. A lock system for securing a bicycle against unauthorized use, said lock system comprising:
a) a scissor-clamp formed by a first arm and a second arm interconnected at a pivot post, each said arm having a gripping claw at one end which grasps a seat tube of a bicycle and an extending finger at a distal end of said arm;
b) a lockbox having a bottom wall and a lid, said bottom wall and said lid engaging said extending finger of each said arm in a closed, latched position securing said extending fingers against movement thereof preventing said scissor clamp from being removed from the seat tube of the bicycle.

2. The lock system of claim 1 further comprising
c) a U-shaped retainer having a first arm with a plurality of cylindrical protrusions, a second arm which can be extended outside said lockbox;
d) a mechanical locking device which engages said first arm of said U-shaped retainer preventing relative movement between said U-shaped retainer and said lockbox;
e) a first ear protruding from a lower side of said bottom of said lockbox on a first side of a wheel of the bicycle, said first ear having a first throughbore;
f) a second ear protruding from a lower side of said bottom of said lockbox on a second side of the wheel of the bicycle, said second ear having a second throughbore which is aligned with said first throughbore;
whereby said second arm of said U-shaped retainer is extended through said first and second aligned throughbores and the wheel of the bicycle, thereby immobilizing the bicycle.

3. The lock system of claim 2 wherein said U-shaped retainer is extended about a post prior to said first arm being engaged by said mechanical locking device thereby securing and immobilizing the bicycle.

4. The lock system of claim 3 wherein said lockbox contains a battery and a electronic actuator for said mechanical locking device.

5. The lock system of claim 4 further comprising a support post extending to said lockbox from a hub of the wheel above which said lockbox sits, said support post providing a path for an electrical connecting wire between a hub generator and said battery contained in said lockbox.

6. The lock system of claim 2 wherein said first arm of said U-shaped retainer includes a plurality of annular protrusions on at least a portion of its length.

7. The lock system of claim 6 wherein said mechanical locking device includes an extendable member having a plurality of teeth which interdigitate with said annular protrusions on said first arm to preclude movement thereof.

8. The lock system of claim 7 further comprising a solenoid attached to said extendable member to disengage said mechanical locking device responsive to an authorized signal from an electronic touch pad.

9. The lock system of claim 1 further comprising at least one illuminated light positioned in said lockbox and shining out through at least one portal on a rear surface of said lockbox to render the bicycle more visible.

10. The lockbox of claim 9 wherein said at least one illuminated light comprises at least two illuminated lights.

11. The lockbox of claim 10 wherein said at least one portal comprises at least two portals on said rear surface of said lockbox.
